(19) United States
(12) Patent Application Publication
(10) Pub. No.: US 2017/0043846 A1
(43) Pub. Date: Feb. 16, 2017

(54) ACCESSORY ATTACHMENT SYSTEM FOR BOARD

(71) Applicant: John Elkinton, Bonita, CA (US)

(72) Inventor: John Elkinton, Bonita, CA (US)

(21) Appl. No.: 15/233,844

(22) Filed: Aug. 10, 2016

Related U.S. Application Data
(60) Provisional application No. 62/203,210, filed on Aug. 10, 2015.

(51) Int. Cl. B63B 35/85; A01K 97/10; B63B 35/79

(52) U.S. Cl. CPC B63B 35/85; B63B 35/79; A01K 97/10; B63B 35/795; B63B 35/7953

(57) ABSTRACT

An attachment system for affixing a number of accessories to an aquatic board. The attachment system includes an attachment bar having a length to extend laterally across a portion of the standup paddleboard. The attachment system further includes a first board clamp attached to the attachment bar at a first end of the attachment bar, and a second board clamp attached to the attachment bar at a second end of the attachment bar. The first board clamp and the second board clamp each have an internal surface to complement and engage with a respective location of the standup paddleboard to attach the accessory attachment system to the portion of the standup paddleboard.

### CROSS-REFERENCE TO RELATED APPLICATION

This application claims the benefit of U.S. Provisional Application Ser. No. 62/203,210, filed on Aug. 10, 2015 and titled “ACCESSORY ATTACHMENT SYSTEM FOR BOARD,” the disclosure of which is incorporated by reference in its entirety.

### FIELD OF THE DISCLOSURE

This disclosure relates to an accessory attachment system for surfboard-type apparatus.

### BACKGROUND

Water-based activities have increased in popularity over the years. Active people in particular are spending a lot of time using non-motorized floating boards, such as surfboard, standup paddle boards, and the like, to spend time on the water. When surfers and paddle boarders spend time out on the water there is the possibility that they become uncomfortable and dehydrated. Surfers and paddle boarders like to be unencumbered and therefore rarely take a bag with supplies, such as sunscreen, water, flotation aids, etc., out on the water with them. Not having some of these supplies can cause a surfer or paddle boarders to spend less time than desired out on the water, or cause the surfer or paddle boarder to forgo, for example, hydrating or applying sunscreen.

### SUMMARY

One aspect of the disclosure relates to a system for attaching accessories to an aquatic board, such as a surfboard or a standup paddleboard. The system can include an attachment bar extending laterally across a standup paddleboard. The attachment bar can be configured to receive one or more accessories for an operator of the standup paddleboard. The system can include a first board clamp operably attached to the attachment bar at a first end of the attachment bar. The first board clamp can be configured to engage with a first side of the standup paddleboard. A second board clamp can be operably attached to the attachment bar at a second end of the attachment bar. The board second clamp can be configured to engage with a second side of the standup paddleboard.

The first board clamp and the second board clamp can operably engage with the first side and the second side of the standup paddleboard to secure the attachment bar in place.

An accessory connector can be engaged with the attachment bar. The accessory connector can be configured to facilitate connection of at least one accessory to the attachment bar. Rails can extend along at least one side of the attachment bar to facilitate slideable engagement of the accessory connector with the attachment bar.

A first board clamp attachment lever can be provided. The board clamp attachment lever can be configured to operably engage with the first board clamp to secure the first board clamp in position. A second board clamp attachment lever can be configured to operably engage with the second board clamp to secure the second board clamp in position.

A first board clamp attachment device can be configured to attach the first board clamp to the attachment bar and provide multiple degrees of freedom to the movement of the first board clamp when the first board clamp is in a non-secured state. A second board clamp attachment device can be configured to attach the second board clamp to the attachment bar and provide multiple degrees of freedom to the movement of the second board clamp when the second board clamp is in a non-secured state. The first board clamp attachment device can be configured to secure the first board clamp in place when the first board clamp is in a secured state. The second board clamp attachment device can be configured to secure the second board clamp in place when the second board clamp is in a secured state.

The accessory attached to the accessory attachment bar can include a handle, rudder, electronic product mount, fishing rod holder, beverage holder, illumination device, sail, flotation device, seat, and/or other accessories.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is an illustration of an attachment system installed on a standup paddle board, the attachment system having one or more elements consistent with the current subject matter;

FIG. 2 is an illustration of an attachment system for an aquatic board with an attachment, having one or more elements consistent with the current subject matter;

FIG. 3 is a perspective view of an attachment system for an aquatic board having one or more elements consistent with the current subject matter;

FIG. 4 is a front view of an attachment system for an aquatic board having one or more elements consistent with the current subject matter;

FIG. 5 is a top view of an attachment system for an aquatic board having one or more elements consistent with the current subject matter;

FIG. 6 is a bottom view of an attachment system for an aquatic board having one or more elements consistent with the current subject matter; and,

FIG. 7 is an illustration of an attachment system installed on a standup paddle board, the attachment system having one or more elements consistent with the current subject matter.

### DETAILED DESCRIPTION

The present disclosure relates to an attachment system for attaching one or more accessories to an aquatic board. In some variations, the attachment system can be an accessory bar disposed laterally across an aquatic board, such as a standup paddleboard. The accessory bar can serve as a base or hub for attaching numerous accessories utilized by the rider or a passenger of the standup paddleboard. The accessory bar can be configured to support multiple accessories, and the accessories can be interchangeable. Examples of uses for attachments can include, but are not limited to, supporting a rider or passenger, facilitating stability of the paddle board, storing items for use by the rider or passenger, facilitating directional control of the paddleboard, attaching items used by a rider or passenger, facilitating mobility of the paddleboard out of the water, visual devices, and/or other uses.

The accessory bar can be attached to any type of aquatic board. Acquatic boards can include, but are not limited to, surfboards, body boards, standup paddleboards, and/or aquatic boards. Examples of standup paddle boards that the contemplated accessory bar can be attached to include hard top paddleboards, soft top paddleboards, inflatable paddleboards, and other types of paddleboards.

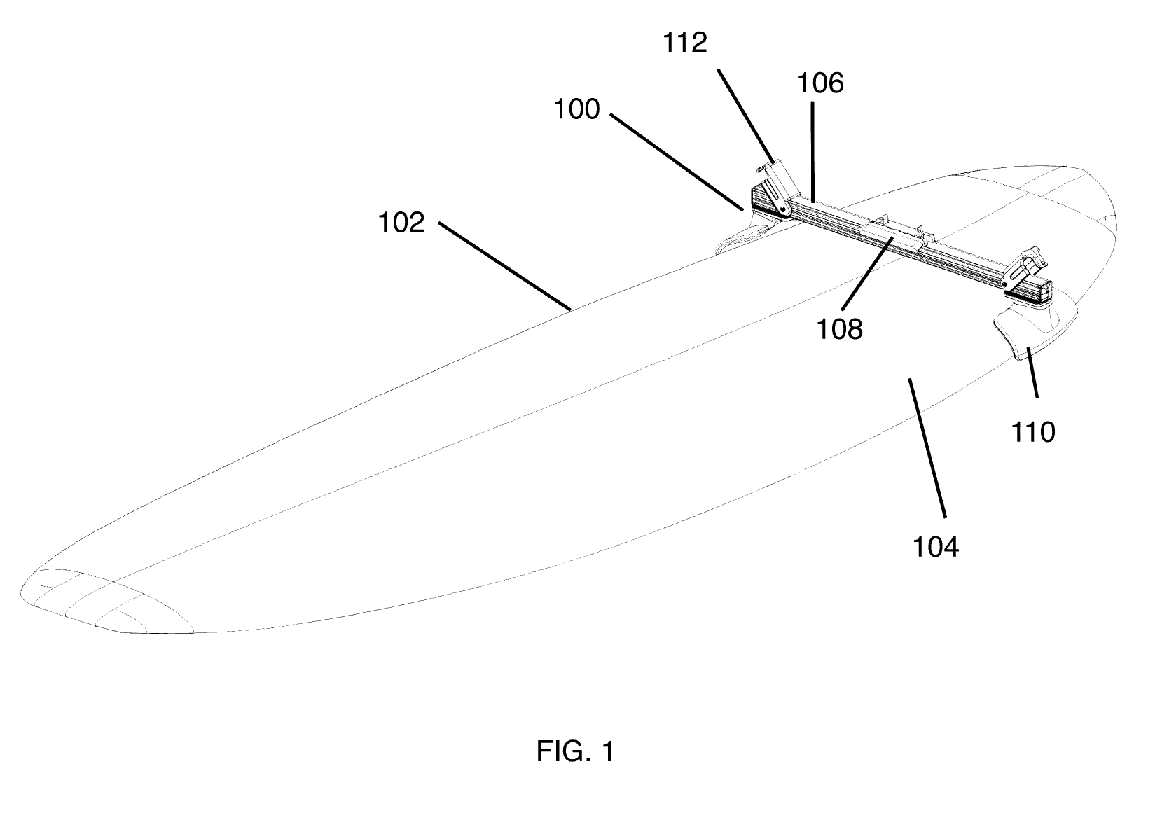

FIG. 1 is an illustration of an accessory attachment system 100 installed on a standup paddleboard 102, having one or more elements consistent with the current subject matter. The accessory attachment system 100 can be disposed at any location on the paddleboard 102. The accessory attachment system 100 can be configured to attach to different sizes of paddleboards. The accessory attachment system 100 can be disposed on a front portion 104 of the standup paddleboard 102.

The accessory attachment system 100 can comprise an accessory bar 106. The accessory bar 106 can be configured to support one or more accessories. The accessory bar 106 can comprise one or more accessory connectors 108. The accessory connectors 108 can be universal connectors configured to receive and secure different accessories to the accessory bar 106. The accessory connectors 108 can be tailored to different accessories. In some variations, accessories for attaching to the accessory bar 106 can include clamps, configured to clamp to the accessory bar 106.

The accessory attachment system 100 can include board clamps 110. The board clamps 110 can be disposed at opposing ends of the accessory bar 106. The board clamps 110 can be configured to grip to the sides, or rails, of the standup paddleboard 102. The board clamps 110 can be activated by locking levers 112. The locking levers 112 can be configured to cause the board clamps 110 to be drawn inward toward the center of the standup paddleboard 102. Drawing the board clamps 110 inward applies a force between the accessory attachment system 100 and the standup paddleboard 102. In some variations, the force applied to the rails of the standup paddleboard 102 can cause the board clamps 110 to embed into the rails of the standup paddleboard 102. In some variations, the force applied to the rails of the standup paddleboard 102 can cause the accessory attachment system 100 to be frictionally secured to the standup paddleboard 102.

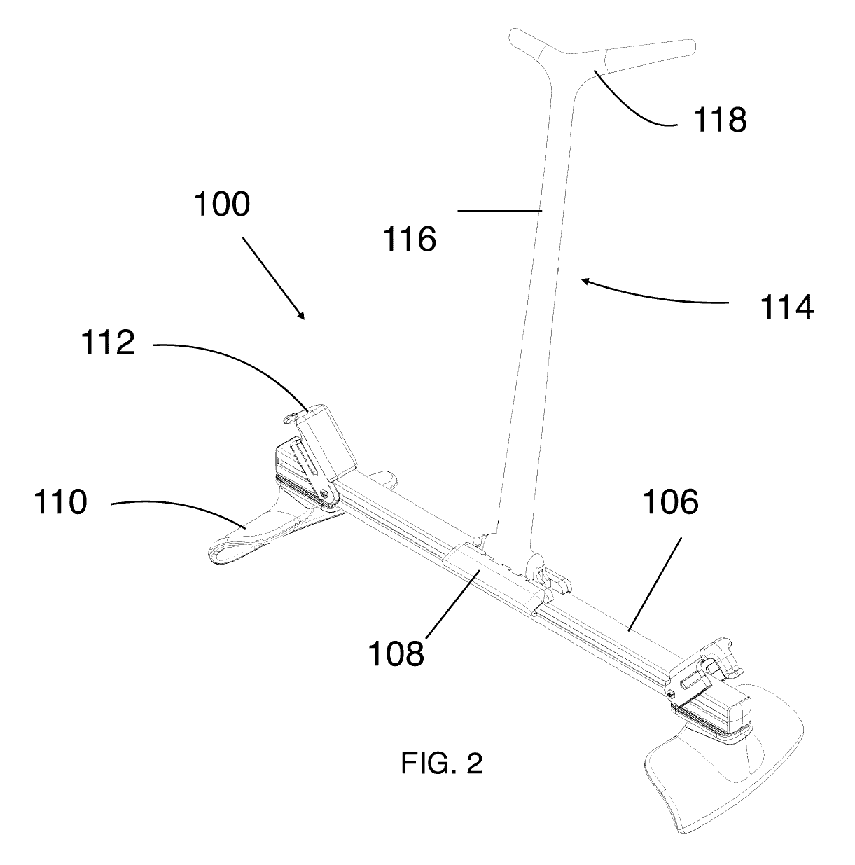

FIG. 2 is an illustration of an accessory attachment system 100 for an aquatic board with an attachment 114, having one or more elements consistent with the current subject matter. The attachment 114 illustrated in FIG. 2 can be a rider support. The rider support can include a stem 116. The rider support can include one or more handles 118. The rider support 114 can be configured to support a rider of the standup paddleboard and/or a passenger of the standup paddleboard.

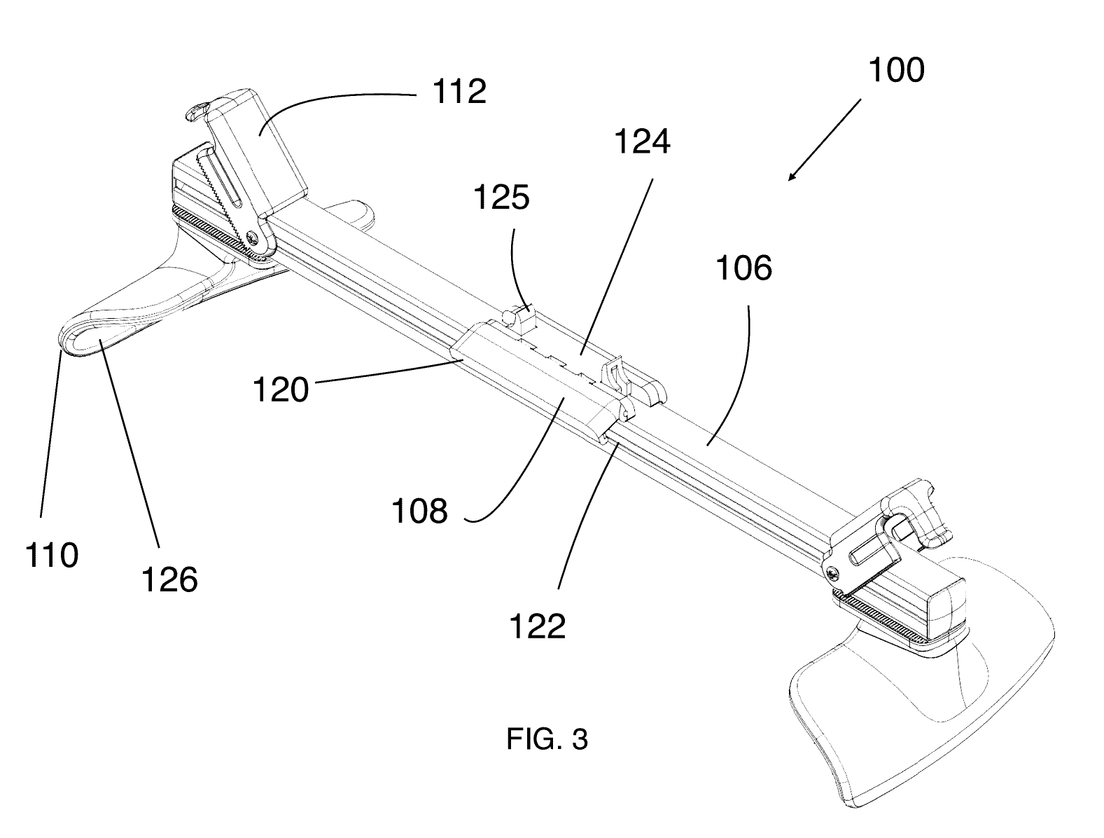

FIG. 3 is a perspective view of an accessory attachment system 100 for an aquatic board having one or more elements consistent with the current subject matter. The accessory connector 108 can include one or more connector flanges 120. The one or more connector flanges 120 can be configured to engage with the accessory bar 106. The accessory bar 106 can include one or more connector channels 122. The connector channels 122 can be disposed along the length of the accessory bar 106. The connector flange(s) 120 can be configured to engage with the connector channels 122. The connector flange(s) 120 can be configured to facilitate positioning of the accessory connector 108 at positions along the accessory bar 106.

The accessory connector 108 can include an accessory port 124. The accessory port 124 can be configured to receive one or more accessories. Accessories can be adapted to securely fit into the accessory port 124. Accessory port locks 126 can be configured to lock one or more accessories into the accessory port 124. The accessory port locks 125 can be configured to engage with the accessory when it is installed into the accessory connector 108. The accessory port locks 125 can include disengagebale locking mechanisms.

The board clamps 110 can include a cushioned surface 126. The cushioned surface 126 can be disposed on an inner surface of the board clamps 110. The cushioned surface 126 can be adjacent the side, or rail, of the standup paddleboard. The cushioned surface 126 can be adapted to distribute the pressure exerted by the clamps over the surface of the board clamps 110, reducing the likelihood of having a pressure spot that would distort the standup paddleboard. The board clamps 110 can be configured to be generally positioned on the rails of the standup paddleboard. Locking levers 112 can be configured to draw the board clamps 110 further toward the middle of the accessory attachment system 100 to secure the accessory attachment system 100 to the standup paddleboard.

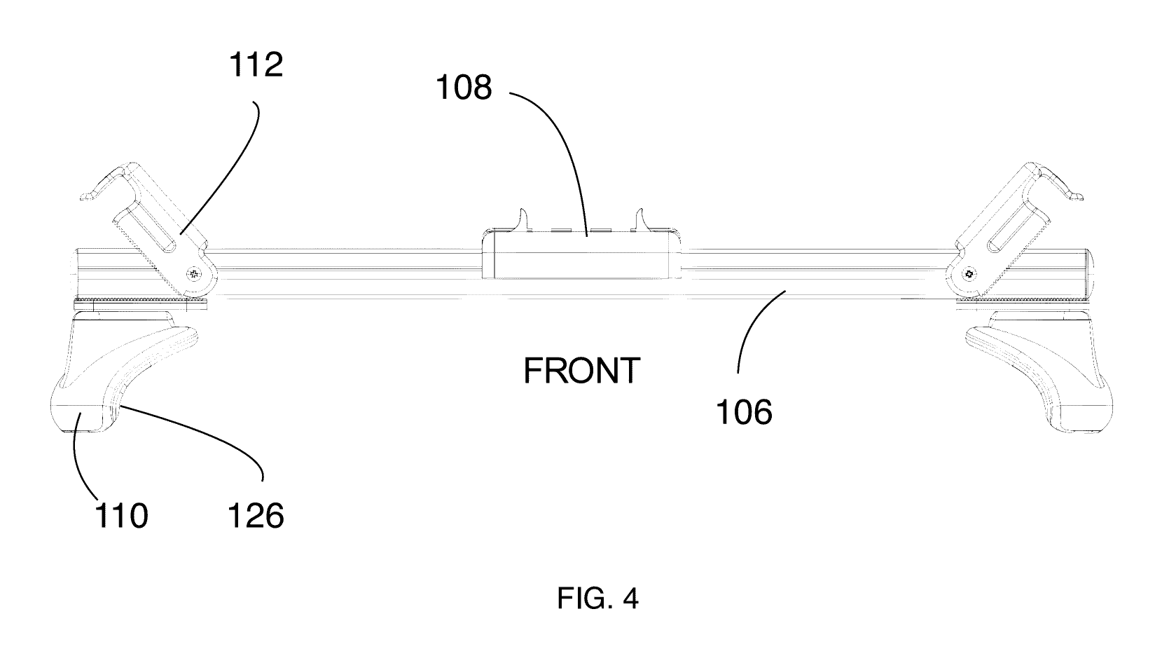

FIG. 4 is a front view of an accessory attachment system 100 for an aquatic board having one or more elements consistent with the current subject matter.

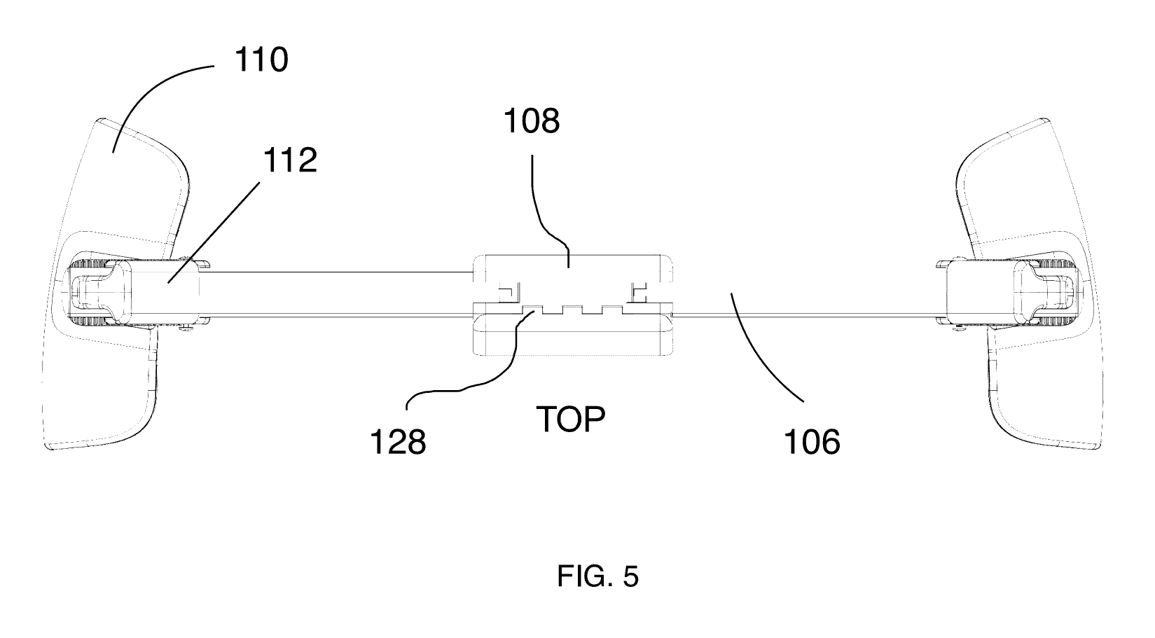

FIG. 5 is a top view of an accessory attachment system 100 for an aquatic board having one or more elements consistent with the current subject matter. The accessory connector 108 can include on or more accessory positioning flanges 128. The accessory positioning flanges 128 can be configured to guide accessories into the accessory connector 108. The accessory flanges 128 can be configured to secure the accessory into a particular position within the accessory connector 108. Accessories can be configured to have flanges and troughs that compliment the accessory flanges 128 of the accessory connector 108. In this manner, accessories can be secured to the accessory connector 108 in a particular orientation. Securing accessories in a particular orientation can be beneficial when the accessories are designed to serve a particular functions where the orientation of that accessory is important to fulfillment of that function.

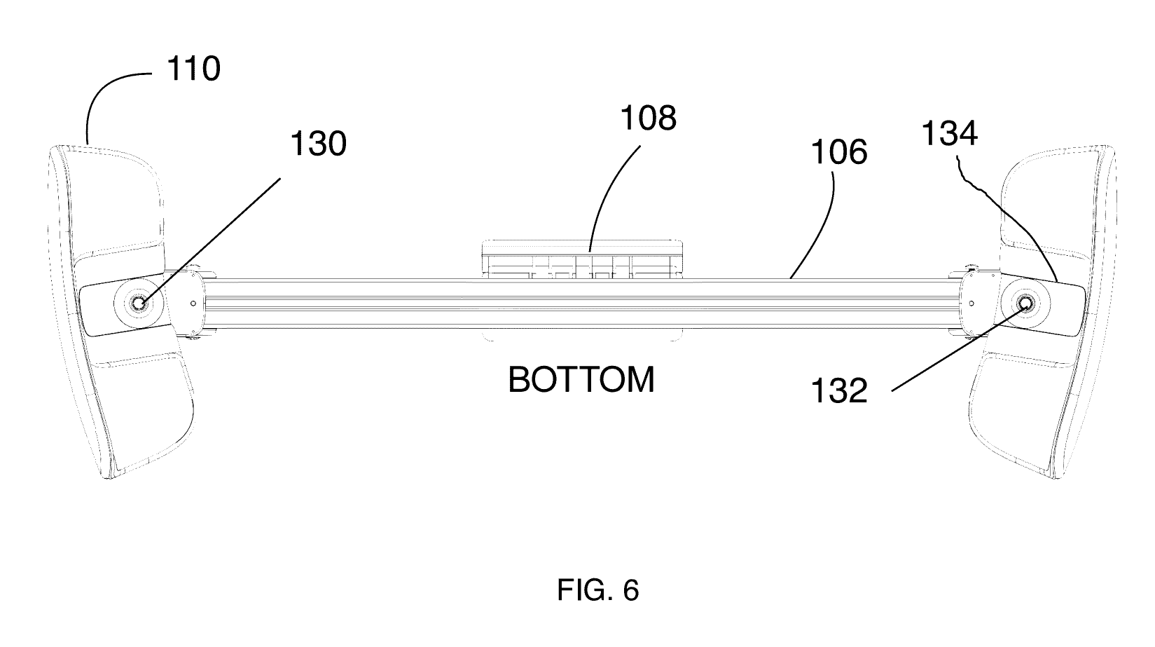

FIG. 6 is a bottom view of an accessory attachment system 100 for an aquatic board having one or more elements consistent with the current subject matter. The clamps 110 can be configured to be rotated about a fulcrum 130. The board clamps 110 can be secured to the accessory bar 106 by a rotatable fixture 132. The rotatable fixture 132 can include a bolt and a nut. The bolt can be disposed to run through the board clamp 110 and be engaged with the locking levers 112. The rotatable fixture 132 can be configured to facilitate rotational positioning of the board clamps 110 such that an internal surface 126 of the board clamps 110 complement the surface of the standup paddleboard at the location where the accessory attachment system 100 is to be affixed.

The rotatable fixture 132 can be configured to provide multiple degrees of freedom to the movement of the board clamps 110. The multiple degrees of freedom to the movement of the board clamps 110 can occur during a non-fixed state of the board clamps 110. The moveable nature of the board clamps 110 can facilitate obtaining a secure fit of the accessory attachment system 100 to the standup paddleboard. The board clamps 110 can slideably engage with the fixture 132. The board clamps 110 can include a fixture slide 134 configured to receive the fixture 132 as the board clamps 110 are slid onto the accessory bar 106. The fixture 132 can be configured to facilitate rotation of the clamps 110 about the fulcrum 130.

The locking levers 112 can be operably engaged with the fixture 132. The locking levers 112 and the fixture 132 can be configured to cause a reduction in the distance between the locking levers 112 and the board clamps 110 causing the fixture 132 and the locking lever 112 to exert a pressure on the board clamps 110 and the accessory bar 106. The pressure exerted on the board clamps 110 and the accessory bar 106 can cause the board clamps 110 to become fixed at a desired position along the accessory bar 106 and also at a desired angle relative to the accessory bar 106 complementing the shape of the standup paddleboard.

The position of the accessory attachment system 100 along the length of the standup paddleboard can be selected based on the accessory, accessories, attached, or intended to be attached, to the accessory bar 106. The accessories 114 for attachment to the accessory bar 106 can include, but are not limited to, a handlebar, a rudder, an electronic product mount, a fishing rod holder, a tackle box, a seat, a beverage holder, a cooler, a sail, wheels, flotation devices, illumination devices, and/or other accessories.

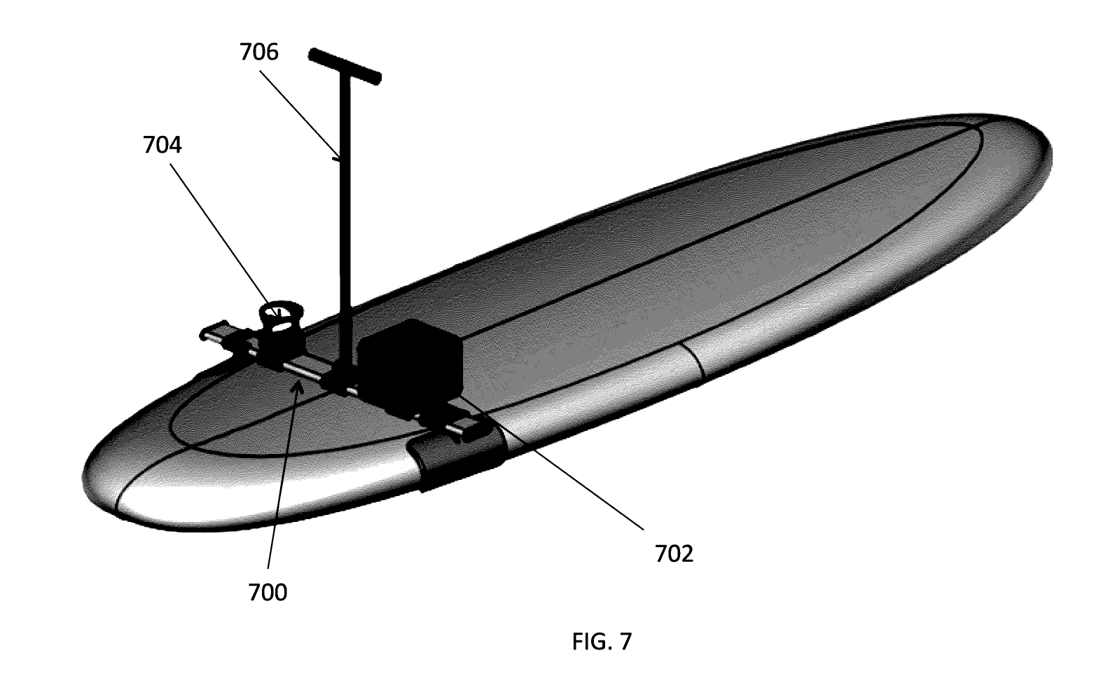

FIG. 7 is an illustration of an accessory attachment system 700 having one or more features consistent with the current subject matter. The accessory attachment system 700 can include a tackle box 702. The accessory attachment system 700 can include a beverage holder 704. The accessory attachment system 700 can include a handle 706.

A rudder can be fixed to the accessory bar in a manner similar to the handle illustrated in FIG. 2. A pivot can be provided in the rudder to facilitate steering of the standup paddleboard. The rudder can include a handle and one or more blades operatively connected to the handle. The blades of the rudder can be attached to the handle via a non-resilient connection or a resilient connection. A resilient connection can include wood, plastic, metal, or other form of resilient material. A non-resilient connection can include string, rope, nylon, rubber, chain, and/or other non-resilient connection.

The connection between the rudder handle and the rudder blades can extend lengthways relative to the standup paddleboard. Such that the connection extends to a blade disposed near the front, or back, of the standup paddleboard. The connection between the rudder handle and the rudder blades can extend sideways relative to the standup paddleboard. Such that the connection extends to one or more blades disposed at the sides of the standup paddleboard.

In some variations, the accessory attachment system can include an electrical supply accessory. The electrical supply accessory can include a water-resilient electrical connectors for electrically charging or powering one or more electronic devices. The accessory attachment system can include a water-resilient speaker. The water-resilient speaker can be configured to wirelessly connect with one or more music players. The music players can include any music player such as a MP3 player, smartphone, streaming music player, or similar music player.

The accessory attached to the accessory attachment system can include a water-resilient box. The water-resilient box can be configured to store electronics or other water-sensitive items. When paired with a water-resilient speaker, music players capable of wirelessly communicating with the water-resilient speaker can be used to play music through the water-resilient speakers.

Illumination devices can be attached to the accessory attachment system. Illumination devices can be configured to provide illumination of an area around the standup paddleboard to facilitate navigation of water by the operator of the standup paddleboard. Illumination can be used as an alert to alert bystanders to a problem. Illumination devices can be configured to provide surface or under-water illumination.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for attaching accessories to a standup paddleboard comprising:
an attachment bar for extending laterally across a standup paddleboard, the attachment bar configured to receive one or more accessories for an operator of the standup paddleboard;
a first board clamp attached to the attachment bar at a first end of the attachment bar, the first board clamp configured to engage with a first side of the standup paddleboard; and,
a second board clamp attached to the attachment bar at a second end of the attachment bar, the second board clamp configured to engage with a second side of the standup paddleboard to secure the attachment bar to the standup paddleboard.

2. The system as in claim 1, further comprising:
an accessory connector engaged with the attachment bar, the accessory connector configured to facilitate connection of at least one accessory to the attachment bar.

3. The system as in claim 2, further comprising:
a rail extending along at least one side of the attachment bar, the rail facilitating slideable engagement of the accessory connector with the attachment bar.

4. The system as in claim 1, further comprising:
a first board clamp attachment lever configured to engage with the first board clamp to secure the first board clamp in position; and,
a second board clamp attachment lever configured to engage with the second board clamp to secure the second board clamp in position.

5. The system as in claim 1, further comprising:
a first board clamp attachment device configured to attach the first board clamp to the attachment bar and provide multiple degrees of freedom to a movement of the first board clamp when the first board clamp is in a non-secured state; and,
a second board clamp attachment device configured to attach the second board clamp to the attachment bar and provide multiple degrees of freedom to a movement of the second board clamp when the second board clamp is in a non-secured state.

6. The system as in claim 5, wherein the first board clamp attachment device is configured to secure the first board clamp in place when the first board clamp is in a secured state and wherein the second board clamp attachment device is configured to secure the second board clamp in place when the second board clamp is in a secured state.

7. The system as in claim 1, wherein the accessory attached to the accessory attachment bar includes a handle.

8. The system as in claim 1, wherein the accessory attached to the accessory attachment bar includes a rudder.

9. The system as in claim 1, wherein the accessory attached to the accessory attachment bar includes an electronic product mount.

10. The system as in claim 1, wherein the accessory attached to the accessory attachment bar includes a fishing rod holder.

11. The system as in claim 1, wherein the accessory attached to the accessory attachment bar includes a beverage holder.

12. The system as in claim 1, wherein the accessory attached to the accessory attachment bar includes an illumination device.

13. The system as in claim 1, wherein the accessory attached to the accessory attachment bar includes a sail.

14. The system as in claim 1, wherein the accessory attached to the accessory attachment bar includes a flotation device.

15. The system as in claim 1, wherein the accessory attached to the accessory attachment bar includes a seat.

16. An accessory attachment system for attaching accessories to a standup paddleboard comprising:
an attachment bar that is configured to extend laterally across the standup paddleboard;
a first board clamp attached to the attachment bar at a first end of the attachment bar, and a second board clamp attached to the attachment bar at a second end of the attachment bar, the first board clamp and the second board clamp each having an internal surface to complement and engage with a respective location of the standup paddleboard to attach the accessory attachment system to the standup paddleboard.

17. An accessory attachment system for a standup paddleboard, the accessory attachment system comprising:
an attachment bar having a length to extend laterally across a portion of the standup paddleboard;
a first board clamp attached to the attachment bar at a first end of the attachment bar, and a second board clamp attached to the attachment bar at a second end of the attachment bar, the first board clamp and the second board clamp each having an internal surface to complement and engage with a respective location of the standup paddleboard to attach the accessory attachment system to the portion of the standup paddleboard; and
at least one accessory that is attachable to the attachment bar.
